(19) United States
(12) Patent Application Publication
(10) Pub. No.: US 2003/0148731 A1
(43) Pub. Date: Aug. 7, 2003

(54) Receiver device of receiving and outputting information relating to a broadcast program and method for the same

(76) Inventors: Takehiro Onomatsu, Osaka (JP); Kenichiro Okabe, Osaka (JP); Toshihiro Takagi, Osaka (JP)

Correspondence Address: Rosenthal & Osha L.L.P., One Houston Center, Suite 2800, 1221 McKinney Street, Houston, TX, 77010, US

(21) Appl. No.: 10/357,746

(22) Filed: Feb. 4, 2003

(30) Foreign Application Priority Data
Feb. 7, 2002 (JP) 2002-030921(P)

(51) Int. Cl. H04H 7/00; H04B 1/18

(52) U.S. Cl. 455/3.06; 455/150.1

(57) ABSTRACT

A receiver device receives a program broadcast signal. When a user selects an intended channel, e.g., via a remote control, a program broadcast signal of the selected channel is extracted from the received program broadcast signal, and an operation of obtaining EPG information from the extracted program broadcast signal is performed. The program information corresponding to the obtained EPG information is displayed on a screen. During the operation of obtaining the EPG information, the current information obtaining portion is cancelled whenever a new channel other than the last selected channel is selected by an operation of the user, and the EPG information obtaining operation for the selected new channel is performed.

### BACKGROUND OF THE INVENTION

1. Field of the Invention

The present invention relates to a receiver device and a method, and particularly to a receiver device and a method for receiving and outputting information relating to a broadcast program.

2. Description of the Background Art

In an analog broadcast, one physical channel broadcasts one program. This physical channel means a frequency band of a carrier wave used for the broadcast of the program.

In a digital broadcast, one physical channel generally broadcasts multiple programs. Therefore, there are two kinds of channels, i.e., a physical channel and a plurality of virtual channels multiplexed with the physical channel. In the digital broadcast system, it is possible to increase significantly the number of programs (virtual channels), which can be broadcast over the physical channel. Therefore, various manners have been proposed for rapidly selecting the channel from the multiple virtual channels.

Japanese Patent Laying-Open No. 2001-045391 has disclosed an improvement in user's operation of a remote control for channel selection. Specifically, categories of a hierarchical structure are employed such that rapid channel selection can be performed at a higher level of the hierarchy, and slow channel selection can be performed at a subdivided lower level. Thereby, the user can easily and rapidly select an intended channel.

Japanese Patent Laying-Open No. 2001-177778 has disclosed a channel display method, in which a receiver device uses a table of TS (Transport Stream) all station service information (all station SI) to display channels. More specifically, when the device receives a signal for channel-up or channel-down, it refers to the all station SI table already prepared to select and display a channel next to a current channel, which is being displayed, in accordance with an order of channels.

The digital broadcast sends program information such as an EPG (Electrical Program Guide) relating to broadcast programs. A digital broadcast receiver device receives the program information, and provides various kinds of service by using the received program information. Since the user can refer to only a limited volume of data at a time, the user selects, e.g., an intended channel from channels guided by the EPG displayed on the screen according to the EPG.

The EPG information is obtained by such an operation that a channel available in the digital or analog broadcast carrying the EPG information is selected, and the digital data corresponding to EPG is obtained from the broadcast signal received on the selected channel.

Both the publications described above have merely disclosed improvements in channel selecting operation, and neither of them has disclosed a technology, in which EPG information corresponding to the selected channel is obtained and displayed as program information.

For outputting the obtained EPG information, the EPG information is displayed on the screen as the program information by an OSD (On Screen Display). FIGS. 9A and 9B show an example of conventional screen display of the EPG by a receiver device of ATSC (Advanced Television Systems Committee) broadcast.

A user operates a key group 100 shown in FIG. 9A for channel switching, and screen display is performed as shown in FIG. 9B according to EPG information related to key group 100 thus operated. When the channel is switched to select a channel “10-2” indicated by an arrow AR in FIG. 9A, a screen 10 based on the EPG information, which is obtained in connection with the channel “10-2”, is displayed as shown in FIG. 9B.

In the ATSC broadcast, digital data called VCT (Virtual Channel Table), EIT (Event Information Table) and ETT (Extended Text Table) are included in the broadcast signal for representing the channel information and the event or program information relating to each channel. By obtaining such data from the broadcast signal, the EPG information can be obtained.

VCT indicates a corresponding channel number and a name of channel, EIT indicates a title of the program broadcast on the corresponding channel and a time of the broadcast, and ETT explains contents of the program broadcast on the corresponding channel. On screen 10 shown in FIG. 9B, information 101 provided by EIT, information 102 provided by VCT and information 103 provided by ETT are displayed.

It is assumed that the user performs an up-down operation on screen 10 shown in FIG. 9B to switch the channel to intended another channel “12-1” indicated by an arrow BR in FIG. 9A. In this case, all information is already prepared on screen 10 by EPG for the last channel “10-2”. Therefore, this channel switching is accepted, and processing starts to obtain the EPG information of the selected new channel “12-1”. When still another channel is selected during this processing of obtaining the EPG information, the EPG information of the channel “12-1” is not yet obtained so that the information for screen 10 is not completed. Therefore, this channel switching operation is deemed invalid, and is rejected.

FIG. 10 schematically shows a manner of obtaining the EPG information in parallel with the channel switching operation. On screen 10 shown on the left in FIG. 10, all information 101-103 relating to the EPG information are obtained and displayed. Therefore, the switching operation for the next channel is accepted when this screen 10 is displayed. On screen 10 shown on the right in FIG. 10, any information 101-103 of the EPG information is not obtained for the selected new channel because such obtaining is being performed. Therefore, the switching operation for the still another channel is not accepted. Even when the user performs the operation for switching to the new channel in the conventional device, as shown in FIG. 10, the operation of obtaining the EPG information of the selected new channel does not start until all data is completely updated based on the EPG information in screen 10 (i.e., until the information is completely prepared). Consequently, the user cannot rapidly obtain the program information relating to the intended channel.

There is also a mode for displaying program information of a plurality of channels and for several hours at a time. FIG. 11 shows an example of a screen displaying the program information of a plurality of channels and for several hours, and more specifically, shows a screen displaying information of programs of three channels for two hours. Hatching in FIG. 11 represents that a cursor to be operated for indicating information on the screen is present in the hatched portion. In this screen structure, information of programs of a plurality of channels for a uniform time is displayed on the same screen. For the channels and time bands other than those displayed on the screen, the information of programs can be displayed by moving the cursor to scroll displayed contents on the screen.

In the above operation, even when scrolling is attempted for displaying next contents on the screen, the scrolling operation is not accepted until the EPG information corresponding to all the program information on the current screen is obtained and displayed. Therefore, the next contents cannot be displayed. More specifically, the cursor on screen 10 shown in the left portion of FIG. 11 indicates a program “MUSIC” at 8:00 on a channel “2”. While this screen 10 is being displayed, a right-arrow key (not shown) for the cursor operation may be operated to instruct a rightward movement of the cursor. Even in this case, this key operation is not accepted because the program information of the channels “4” and “6” is not completely prepared (and is not displayed) on screen 10. Thereafter, the key operation for the cursor movement is accepted when all the information is completed on screen 10, as shown in the central portion of FIG. 11. For example, when an up-arrow key (not shown) is operated to instruct movement of the cursor to a channel “1”, the instruction by this key operation is accepted, and contents are displayed on screen 10 as shown in the right portion of FIG. 11.

As described above, the key operation for referring to intended program information is not accepted until the EPG information is completely obtained and the corresponding program information is completely displayed on the screen. Therefore, the user cannot rapidly obtain the program information of the intended channel.

### SUMMARY OF THE INVENTION

An object of the invention is to provide a receiver device and a method, which can rapidly obtain intended program information.

For achieving the above object, a receiver device according to an aspect of the invention includes a channel selection operating portion to be operated for selecting a channel, a program information obtaining portion and a display portion for displaying program information obtained by the program information obtaining portion on a screen.

The program information obtaining portion extracts a program broadcast signal of the selected channel from a received program broadcast signal, and performs an information obtaining operation for obtaining the program information representing information related to the program from the extracted program broadcast signal when the channel is selected via the channel selection operating portion. The program information obtaining portion cancels the current information obtaining operation whenever a new channel other than the last selected channel is selected by the channel selection operating portion during the information obtaining operation, and performs the information obtaining operation for the selected new channel.

According to the receiver device described above, if another channel is selected, the information obtaining operation, which is being performed, is cancelled even during the operation of obtaining the program information of the intended channel previously selected, and the operation of obtaining the information of the new intended channel is performed.

Accordingly, the user is not required to wait for obtaining of the program information of the unintended channel, and the operation of obtaining the program information of the intended channel can be rapidly started by merely performing the channel selecting operation or manipulation. Therefore, the intended program information can be rapidly obtained and recognized on the display portion.

According to the above receiver, it is desirable that the display portion has a channel-corresponding display portion configured to correspond to each of the plurality of channels for displaying channel data identifying the channel and the program information of one or more programs obtained by the program information obtaining portion in a table form on a screen. The channel selection operating portion has a cursor operating portion to be operated for moving a cursor prepared in advance on the screen to indicate contents corresponding to the intended channel among the plurality of channels in the table displayed by the channel-corresponding display portion for selecting the intended channel.

According to the above receiver device, the program information of the one or more programs obtained by the program information obtaining portion is displayed corresponding to each of the plurality of channels on the screen. Therefore, the program information of the plurality of channels can be displayed in a list form.

Since the channel corresponding to the contents, which are indicated by moving the cursor, is selected, the program information can be retrieved (obtained and displayed) for the intended channel while confirming the contents displayed in the list form.

In the receiver device, it is desirable that data explaining the program contents of the program information corresponding to the displayed contents is displayed on the same screen every time said cursor indicates the above displayed contents. Therefore, a user can confirm the contents of the program designated by the cursor on the same screen every time the program is designated by the cursor, which is being moved.

In the receiver device described above, it is desirable that the display portion successively displays on the screen the program information obtained during the information obtaining operation. Therefore, even the program information obtained in connection with the channel, which is passed during the operation of moving the cursor to the intended channel, can be successively displayed on the screen.

In the receiver device, it is desirable that the cursor operating portion allows movement of the cursor by program in a portion of the table displaying the program information already obtained by the program information obtaining portion, and allows movement of the cursor by predetermined time length in a portion corresponding to the program information not obtained.

According to the above receiver device, the user can rapidly move the cursor for recognizing the contents in the portion of the table displaying the program information already obtained, and can obtain the information as much as possible by slowly moving the cursor in the portion corresponding to the program information not obtained.

For achieving the foregoing object, a receiving method according to an aspect of the invention includes a channel selecting step for selecting a channel, a program information obtaining step and a display step. In the program information obtaining step, a program broadcast signal of the channel selected in the channel selecting step is extracted from a received program broadcast signal, and an information obtaining operation is performed for obtaining the program information representing information related to the program from the extracted program broadcast signal. In the display step, the program information obtained in the program information obtaining step is displayed. In the program information obtaining step, the current information obtaining operation is cancelled whenever a new channel other than the last selected channel is selected in the channel selecting step during the information obtaining operation, and the information obtaining operation for the selected new channel is performed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a receiver device 1 employed in embodiments of the invention as well as a structure of its peripheral portion;

FIG. 2 is a flowchart of processing for obtaining EPG information in response to a channel switching operation or manipulation according to a first embodiment;

FIG. 3 schematically illustrates an EPG information request operation performed in response to the channel switching on a time basis according to the first embodiment;

FIG. 4 shows an example of a screen displaying program information based on the EPG information according to the first embodiment;

FIG. 5 is a flowchart illustrating processing for obtaining the EPG information according to a second embodiment;

FIG. 6 shows an example of a screen displaying program information of a plurality of channels and for several hours at a time according to the second embodiment;

FIG. 7 illustrates changes caused by channel switching in EPG information obtaining request with the passage of time according to the second embodiment;

FIGS. 8A-8E show examples of a screen of a display portion 3 displaying program information according to the second embodiment;

FIGS. 9A and 9B show, by way of example, keys to be operated for channel switching and a screen displaying EPG information related to the keys in the prior art;

FIG. 10 schematically shows a manner of obtaining the EPG information in parallel with the channel selecting operation in the prior art; and

FIG. 11 shows an example of a screen displaying the program information of a plurality of channels and for several-hours in the prior art.

### DESCRIPTION OF THE PREFERRED EMBODIMENTS

Embodiments of the invention will now be described in detail with reference to the drawings.

(First Embodiment)

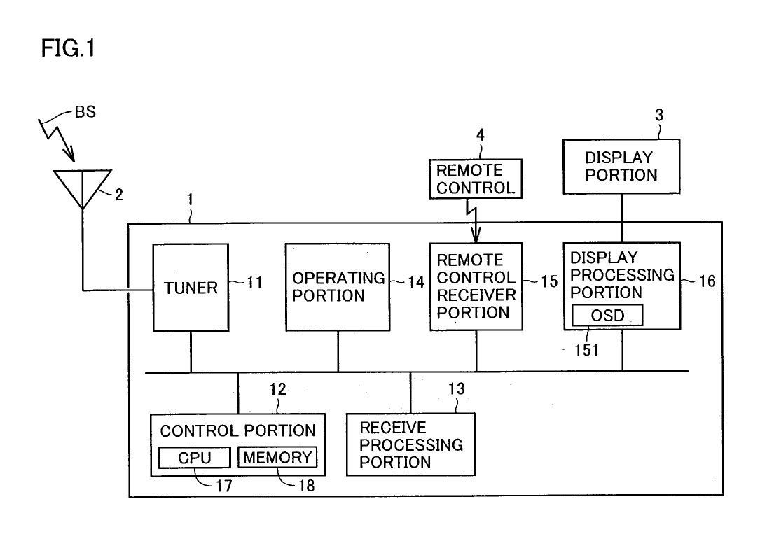

FIG. 1 shows a structure of a receiver device 1 employed in each of embodiments of the invention as well as a structure of its peripheral portion. In FIG. 1, receiver device 1 receives a broadcast signal BS via an antenna 2, and performs processing, which includes obtaining of EPG information, on a signal corresponding to an intended channel to display processed contents as well as the obtained EPG information on a display portion 3 such as a TV receiver.

Receiver device 1 includes a tuner 11 for selectively extracting a signal corresponding to a channel selected by an user from broadcast signal BS received via antenna 2, a control portion 12 including a CPU (Central Processing Unit) 17 and a memory 18, a receive processing portion 13 for converting the signal, which is extracted by tuner 11 and corresponds to the intended channel, into a signal processible by receiver device 1, an operating portion 14, which is arranged on a front panel (not shown) and includes buttons and others to be operated by the user, a remote control receiver portion 15 for receiving an infrared signal from an external remote control 4, and a display processing portion 16 including an OSD (On Screen Display) 161.

When the user operates operating portion 14 directly or via remote control 4 and remote control receiver portion 15 to select and designate an intended channel, information of the designated channel is given to control portion 12. CPU 17 of control portion 12 controls tuner 11 based on the given information of the intended channel to extract a signal corresponding to the intended channel from received broadcast signal BS.

Receiver device 1 can receive an ATSC signal and a NTSC (National Television System Committee standards) signal. Since the ATSC signal includes the program information called VCT, EIT and ETT as described above, the EPG information is obtained by obtaining such program information from the received ATSC signal.

Since the NTSC signal includes digital information related to the programs in VBI (Vertical Blanking Interval), the EPG information of the program related to the NTSC signal is obtained by obtaining such digital information. Receive processing portion 13 has a function of receiving and processing the ATSC signal or NTSC signal corresponding to the intended channel extracted via tuner 11. Receive processing portion 13 performs the processing to obtain the EPG information from the ATSC and NTSC signals, and provides the EPG information thus obtained to control portion 12.

CPU 17 prepares image data of the program information based on the EPG information provided from control portion 12, and provides it to display processing portion 16. OSD 161 in display processing portion 16 performs the processing to display the characters and/or images based on the received image data on the screen of display portion 3 in a superimposed manner.

According to receiver device 1 of this embodiment, when a request made by a user for obtaining the EPG information relating to another channel (i.e., new channel) is detected based on the output from remote control 4 via remote control receiver portion 15 or the operation of operating portion 14, an operation of obtaining the EPG information of the new channel starts independently of completion and incompletion of the current processing for obtaining the EPG information (i.e., independently of whether the program information for the screen display is fully prepared or not).

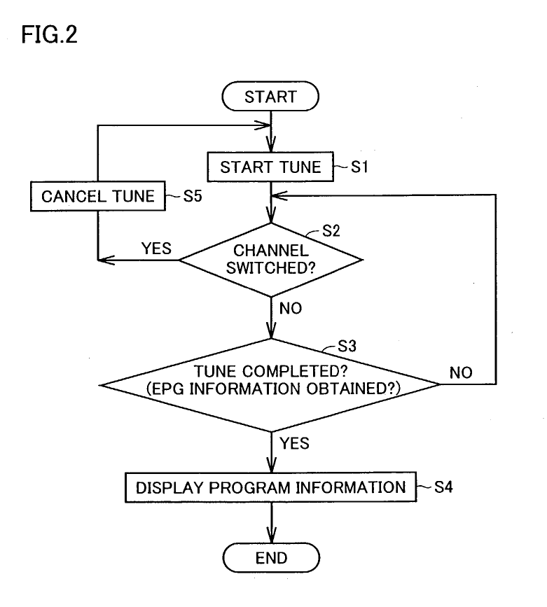

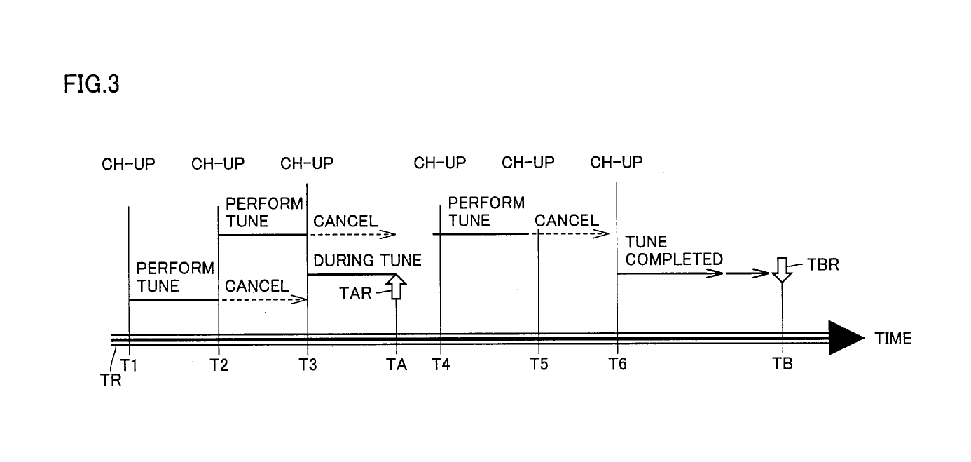

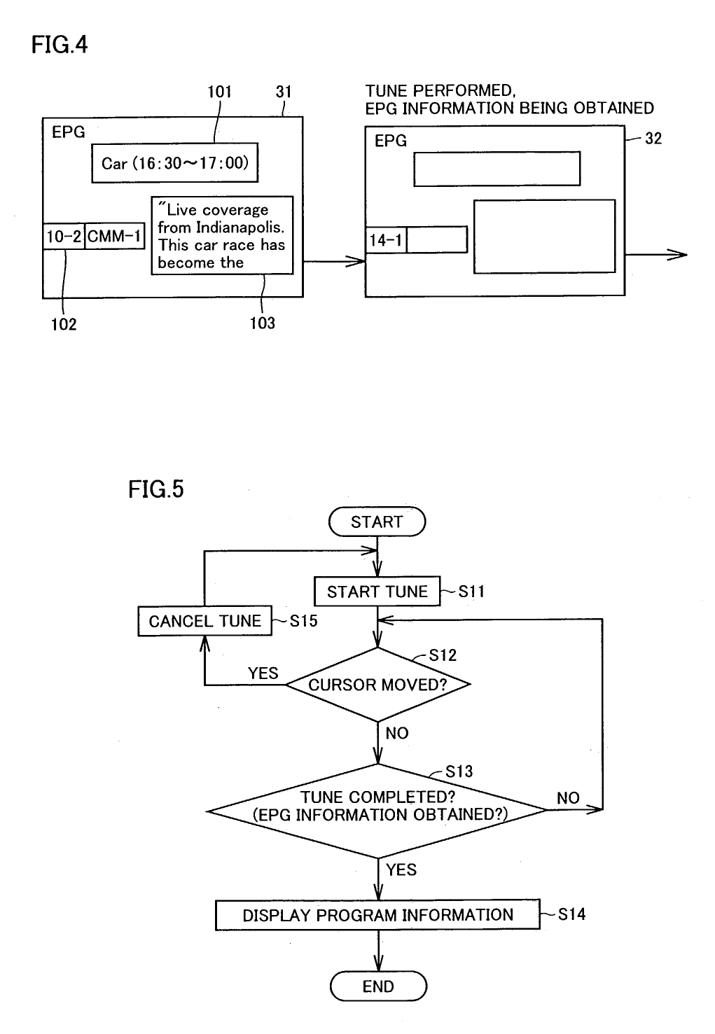

FIG. 2 is a flowchart of processing for obtaining the EPG information in accordance with channel switching according to the first embodiment. FIG. 3 schematically illustrates an EPG information request operation performed in response to the channel switching on a time basis according to the first embodiment. FIG. 4 shows an example of a screen displaying the program information based on the EPG information according to the first embodiment.

Referring to the flowchart of FIG. 2, the operation of receiver device 1 will now be described. It is assumed that receiver device 1 is in a mode for screen display based on the EPG information, and display portion 3 is displaying a screen 31 for program information of a channel “10-2” in a left portion of FIG. 4. In this state, it is assumed that the user intends to display the program information of another channel “14-1”, and therefore operates operating portion 14 or remote control 4 to select the new channel “14-1”. In response to it, tuner 11 starts an operation (which will be referred to as a “TUNE operation” hereinafter) of extracting a signal corresponding to the channel “14-1” from broadcast signal BS received via antenna 2 (step S1). In this state, display portion 3 provides a screen 32 shown in a right portion of FIG. 4. Even during the TUNE operation, CPU 17 determines whether the channel switching operation was performed or not, i.e., whether the user performed the operation of selecting another channel or not (S2). When it is determined that the channel switching operation was performed (YES in step S2), CPU 17 cancels the current TUNE operation of tuner 11 (step S5), and controls tuner 11 to start the TUNE operation of extracting the signal corresponding to the selected new channel (step S1). Thereafter, the processing in and after the step S2 is similarly repeated.

If the operation of switching to a different channel is not detected during the TUNE operation of tuner 11 (NO in step S2), and obtaining of the EPG information is completed (YES in step S3), display portion 3 displays the program information of the intended channel through OSD 161 of display processing portion 16 based on the EPG information thus obtained (step S4).

When the processing is performed to determine whether the switching operation of the new channel is performed or not, and the switching operation is detected during a period from start of the TUNE operation by tuner 11 to the completion of the TUNE operation and the obtaining of EPG information, the switching operation is accepted regardless of completion and incompletion of the EPG information obtaining operation, the TUNE operation, which is being performed, is cancelled, and the TUNE operation for the new channel starts.

States for obtaining the EPG information in accordance with the channel switching operation will now be described with reference to FIG. 3. With the passage of time indicated by an arrow TR in FIG. 3, operating portion 14 or remote control 4 is operated to perform a channel-up (CH-UP) operation for incrementing a channel number to select another new channel. Upon every switching operation (channel-up operation), which is performed for selecting a new channel in accordance with timing T1-T6 illustrated in FIG. 3, the current TUNE operation, which is being performed, is cancelled and a new TUNE operation for the new channel starts. When the TUNE operation and therefore the EPG information obtaining operation are completed, display portion 3 displays the program information relating to the EPG information thus obtained on the screen through OSD 161. In FIG. 3, an arrow TA indicates timing TA and particularly a chance to obtain the EPG information, and an arrow TBR indicates timing TB and particularly the completion of the EPG information obtaining operation.

According to the first embodiment, even before the EPG information is completely obtained, the current TUNE operation is cancelled to start the TUNE operation for obtaining the EPG information of the selected new channel. Therefore, the EPG information of the channel desired by the user can be rapidly obtained. Consequently, display portion 3 can rapidly display the program information corresponding to the new channel selected by the user on its program information display screen.

(Second Embodiment)

The EPG information may include data, which is formed of packages each having a length of six hours, for up to two weeks. In a second embodiment described below, the program information for several hours is collectively displayed on the screen based on such EPG information.

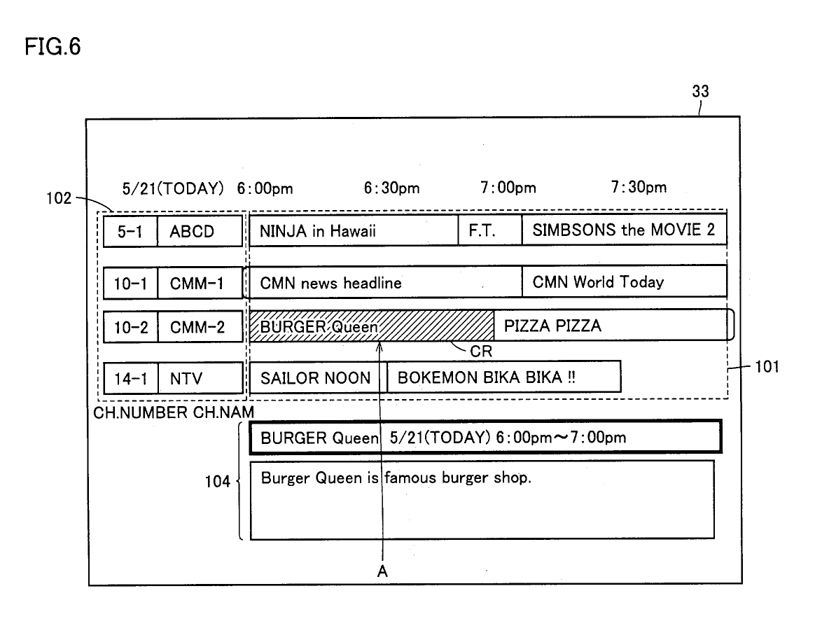

FIG. 5 is a flowchart illustrating processing for obtaining the EPG information according to the second embodiment. On a screen 33 shown in FIG. 6, OSD 161 of display processing portion 16 displays information 102, which correspond to the plurality of channels for identifying the respective channels, and information 101 relating to the programs obtained for these channels in a table form. On screen 33, cursor CR is moved within a display area of information 102 corresponding to the plurality of channels by operating portion 14 or remote control 4 so that the channel and the program can be selected. FIG. 6 shows a state on screen 33, in which cursor CR selects a channel “10-2” and a program title “BURGER Queen” as indicated by an arrow A. Every time the program title is selected by moving cursor CR, OSD 161 of display processing portion 16 displays explanation data 104 for explaining contents of the program corresponding to the selected program title on the same screen 33. Program explanation data 104 is displayed after being edited based on information 101 and 103.

On screen 33 shown in FIG. 6, OSD 161 of display processing portion 16 displays, as information 102, numbers (and names) “5-1” (“ABCD”), “10-1” (“CMM-1”), “10-2” (“CMM-2”) and “14-1” (“NTV”) respectively identifying four channels, and also displays, as information 101, program information relating to one or more programs of a length of two hours. By moving up or down cursor CR indicated by arrow A on screen 33, another channel can be selected. The EPG information of the plurality of channels and for a certain time is obtained and displayed as the program information on screen 33. Channels other than those displayed on screen 33 as well as information in time bands other than those displayed on screen 33 can be displayed by moving cursor CR indicated by arrow A to scroll the displayed contents.

According to the second embodiment, even when the EPG information corresponding to the program information displayed on the screen is not yet obtained completely, the device accepts the operation of moving cursor CR to scroll and display next contents. Thereby, if the user wishes to determine from data 104 the program explanation of the program to be broadcast after several days, the device accepts the operation of moving cursor CR to the right on screen 33 for such determination. Thus, it is possible to move cursor CR to the intended program without waiting for completion of display of information of all the programs to be broadcast during several days from the time in the information, which is currently displayed on screen 33. Also, it is possible to display the program information based on the EPG information, which is obtained by the TUNE operation during movement of cursor CR.

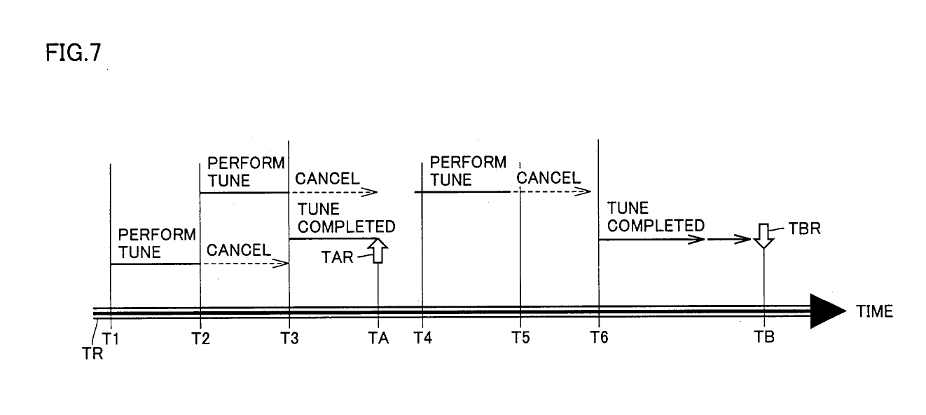

A request for obtaining the EPG information is made in accordance with movement of cursor CR and thus channel selection, and changes in such request with time indicated by an arrow TR are illustrated in FIG. 7.

Referring to FIG. 7, description will now be given on the EPG information obtaining operation performed in accordance with the flowchart of FIG. 5. In FIG. 7, when the user moves cursor CR to select an intended channel, CPU 17 in control portion 12 controls tuner 11 to start the TUNE operation for the intended channel thus selected (step S11). If the channel switching operation performed by moving cursor CR is not detected during a period between the start and end of the TUNE operation, i.e., before the operation of obtaining the EPG information is completed (NO in step S12 and YES in step S13), CPU 17 displays the program information for several hours on display portion 3 through OSD 161 based on the obtained EPG information (S14).

Conversely, when switching to another channel by moving cursor CR is detected between the start and end of the TUNE operation (YES in step S12), the current TUNE operation is cancelled (step S15), and tuner 11 starts the TUNE operation for the selected new channel (step S11).

According to the illustration in FIG. 7, as described above, whenever cursor CR moves to request the switching to another channel in accordance with timing T1-T6, this request is accepted even during the TUNE operation of tuner 11. Thereby, the current TUNE operation (EPG information obtaining processing) is cancelled, and the TUNE operation for obtaining the EPG information of the new channel starts. Therefore, the EPG information of the channel desired by the user can be rapidly obtained, and the program information can be rapidly provided to the user via display portion 3. In FIG. 7, an arrow TAR at timing TA indicates a chance of updating the EPG information, and an arrow TBR at timing TB indicates completion of the EPG information obtaining operation.

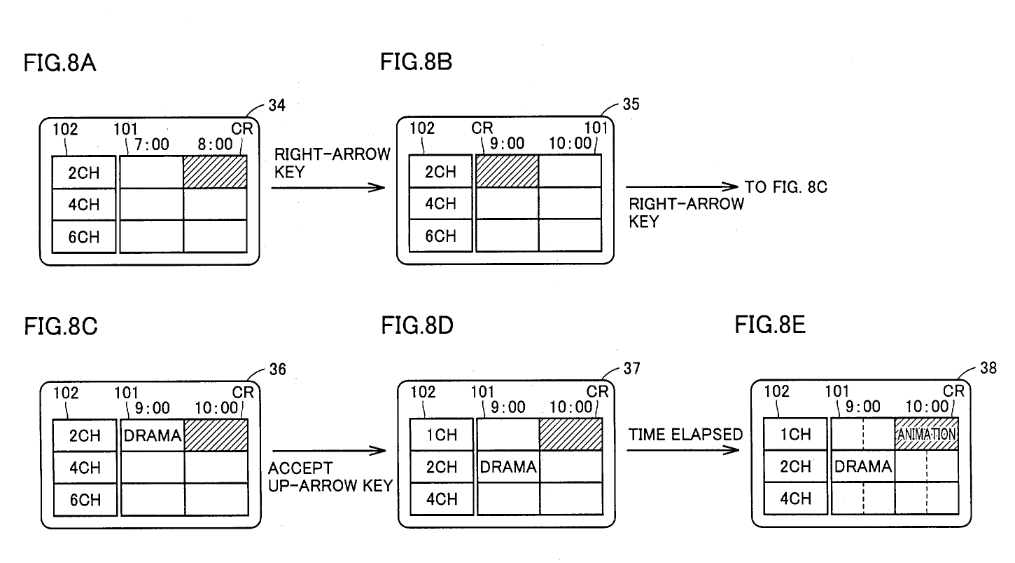

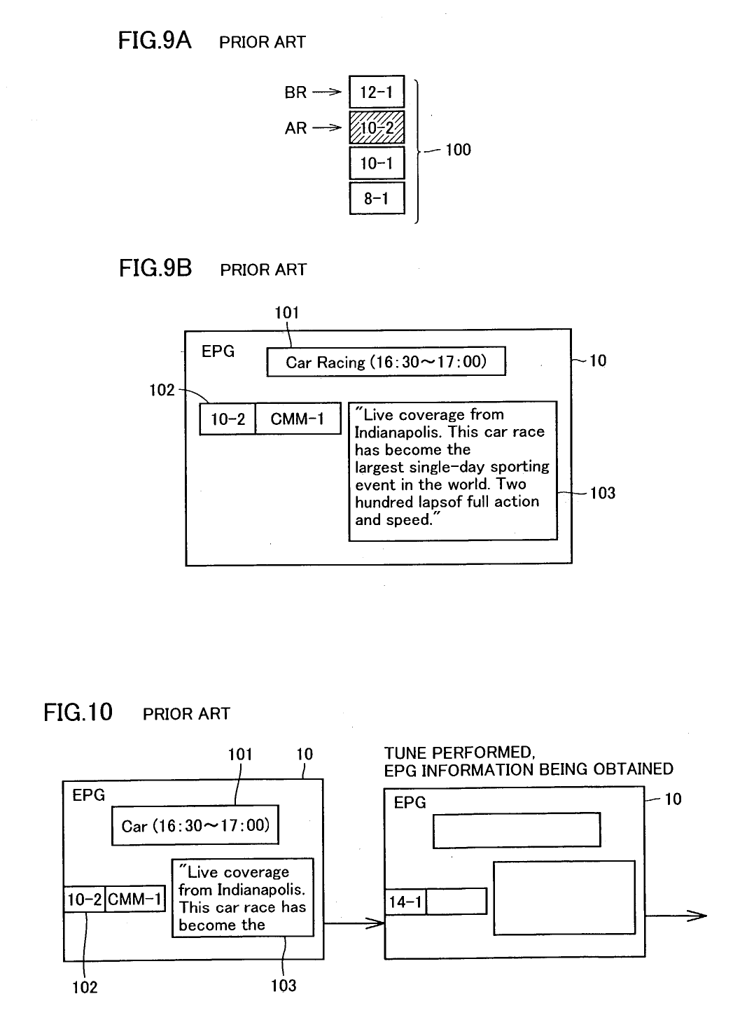

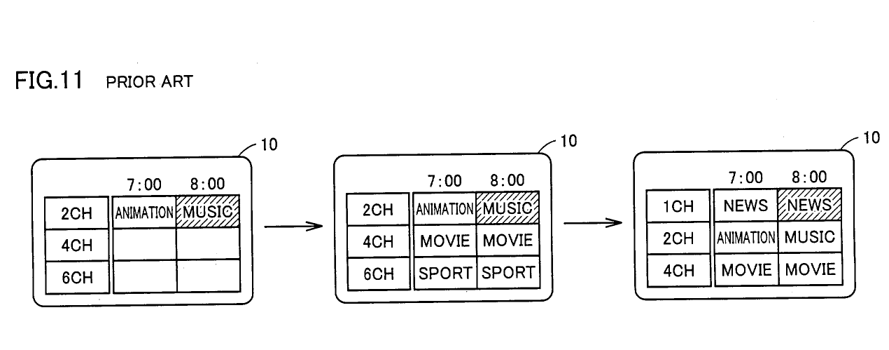

The movement of cursor CR and the switching of the EPG information to be obtained will now be described with reference to FIGS. 8A-8E showing screens 34-38 displaying the program information, respectively. On each of screens 34-38 in FIGS. 8A-8E, the program information of three channels and for two hours can be displayed. On screens 34-38 in FIGS. 8A-8E, blank portions represent that the corresponding EPG information is not yet completely obtained.

It is now assumed that screen 34 in FIG. 8A is displayed. On screen 34, program information of channels “2”, “4” and “6” and for two hours of 7:00-8:00 and 8:00-9:00 is displayed. Cursor CR is present on an area of channel “2” in a time band of 8:00-9:00. Therefore, the processing of obtaining the EPG information (i.e., TUNE operation) is performed for the channel “2”.

It is assumed that the user moves cursor CR to the right for determining the program information of the channel “1” at 10:00 during the processing of obtaining the EPG information of the channel “2”. In this case, the user first operates a right-arrow key (not shown) on operating portion 14 or remote control 4 for moving cursor CR to the right on screen 34, and CPU 17 in control portion 12 accepts the operation of the right-arrow key, and moves cursor CR via OSD 161 to the position of channel “2” in another time band of 9:00—(not shown on screen 34). In this operation, display portion 3 updates the screen from screen 34 to screen 35 in FIG. 8B. When the user further operates the right-arrow key, cursor CR moves to the position of channel “2” at 10:00. This movement updates the screen from screen 35 to screen 36 in FIG. 8C.

As described above, when cursor CR moves as shown in FIGS. 8A, 8B and 8C, the TUNE operation is performed in parallel with the cursor movement to obtain the EPG information of the channel “2”. When the operation of obtaining the EPG information is completed during the movement of cursor CR, the program information based on the EPG information thus obtained is displayed, as can be seen on screen 36 in FIG. 8C. Screen 36 represents that the program on channel “2” at 9:00 is “drama”.

Then, the user operates an up-arrow key (not shown) for moving cursor CR upward on screen 36 so that cursor CR is located at a position of the desired channel “1” at 10:00. Thereby, the screen is updated from screen 36 to screen 37 in FIG. 8D. In response to this movement of cursor CR, CPU 17 detects the switching of the channel from “1” to “2”, and therefore controls tuner 11 to cancel the current TUNE operation and start the TUNE operation for the new channel “1”. Thereby, the operation of obtaining the EPG information of the channel “1” starts. When the EPG information for the program on the intended channel “1” at 10:00 is completely obtained, screen 37 changes to screen 38 in FIG. 8E. The user views the information on screen 38 to know that the intended program is “animation”.

On the screen displaying the program information according to the EPG information in the embodiment, the grid-movement of the time axis of cursor CR may be performed as follows. As shown in FIG. 8E, cursor CR is moved by program (unit of program information) if the EPG information corresponding to the position of the cursor is already obtained (i.e., in the broadcast band of the channel “1” at 10:00 and the broadcast band of the channel “2” at 9:00). Meanwhile, in the area where the corresponding EPG information is not obtained (i.e., in the broadcast bands of channel “1” at 9:00, of channel “2” at 10:00 and of channel “4” at 9:00 and 10:00), the time axis may be moved, e.g., by 30 minutes at a time as indicated by dotted line in FIG. 8E. In this manner, the program information of the EPG information already obtained can be recognized by rapidly moving cursor CR. Also, for the EPG information not obtained, cursor CR moves slowly so that a time required for obtaining such EPG information can be ensured.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A receiver device comprising:
channel selection operating means to be operated for selecting an intended channel;
program information obtaining means for extracting a program broadcast signal of the selected channel from a received program broadcast signal, and performing an information obtaining operation for obtaining the program information representing information related to the program from the extracted program broadcast signal when said channel is selected via said channel selection operating means; and
channel-corresponding display means configured to correspond to each of the plurality of channels for displaying channel data identifying said channel and said program information of one or more programs obtained by said program information obtaining means in a table form on a screen, wherein
said channel selection operating means has cursor operating means to be operated for moving a cursor prepared in advance on said screen to indicate contents corresponding to said intended channel among said plurality of channels in said table displayed by said channel-corresponding display means for selecting said intended channel,
said program information obtaining means has means for canceling the current information obtaining operation whenever a new channel other than the last selected channel is selected by said channel selection operating means during said information obtaining operation, and performing said information obtaining operation for said selected new channel,
said channel-corresponding display means has means for successively displaying on said screen said program information obtained during said information obtaining operation, and
said channel selection operating means has means for allowing movement of said cursor by program in a portion of said table displaying said program information already obtained by said program information obtaining means, and allowing movement of said cursor by predetermined time length in a portion corresponding to the program information not obtained.

2. A receiver device comprising:
channel selection operating means to be operated for selecting a channel;
program information obtaining means for extracting a program broadcast signal of the selected channel from a received program broadcast signal, and performing an information obtaining operation for obtaining the program information representing information related to the program from the extracted program broadcast signal when said channel is selected via said channel selection operating means; and
display means for displaying said program information obtained by said program information obtaining means on a screen, wherein
said program information obtaining means has means for canceling the current information obtaining operation whenever a new channel other than the last selected channel is selected by said channel selection operating means during said information obtaining operation, and performing said information obtaining operation for said selected new channel.

3. The receiver device according to claim 2, wherein
said display means has channel-corresponding display means configured to correspond to each of a plurality of channels for displaying channel data identifying said channel and said program information of one or more programs obtained by said program information obtaining means in a table form on said screen, and
said channel selection operating means has cursor operating means to be operated for moving a cursor prepared in advance on said screen to indicate displayed contents corresponding to an intended channel among said plurality of channels in said table displayed by said channel-corresponding display means for selecting said intended channel.

4. The receiver device according to claim 3, wherein
data explaining program contents of said program information corresponding to the displayed contents is displayed on the same screen every time said cursor indicates said displayed contents.

5. The receiver device according to claim 3, wherein
said cursor operating means allows movement of said cursor by program in a portion of said table displaying said program information already obtained by said program information obtaining means, and allows movement of said cursor by predetermined time length in a portion corresponding to the program information not obtained.

6. The receiver device according to claim 2, wherein
said display means successively displays on said screen said program information obtained during said information obtaining operation.

7. A receiving method comprising:
a channel selecting step of selecting a channel;
a program information obtaining step of extracting a program broadcast signal of said channel selected in said channel selecting step from a received program broadcast signal, and performing an information obtaining operation for obtaining the program information representing information related to the program from said extracted program broadcast signal; and
a display step of displaying said program information obtained in the program information obtaining step, wherein
said program information obtaining step has a step of canceling the current information obtaining operation whenever a new channel other than the last selected channel is selected in said channel selecting step during said information obtaining operation, and performing said information obtaining operation for said selected new channel.
